(19) United States
(12) Patent Application Publication
(10) Pub. No.: US 2010/0065775 A1
(43) Pub. Date: Mar. 18, 2010

(54) NOVEL MARTERIALS INCLUDING ELEMENTS OF GROUP 14

(75) Inventors: David Zitoun, Montpellier (FR); Claude Belin, Montpellier (FR); Monique Tillard, Montpellier (FR)

Correspondence Address: ARENT FOX LLP, 1050 CONNECTICUT AVENUE, N.W., SUITE 400, WASHINGTON, DC, 20036, US

(73) Assignee: Centre National De La Recherche Scientifique - CNRS -, Paris (FR)

(21) Appl. No.: 12/528,269

(22) PCT Filed: Feb. 21, 2008
(86) PCT No.: PCT/FR08/00226

§ 371 Date: Nov. 23, 2009

(30) Foreign Application Priority Data
Feb. 22, 2007 (FR) 07/01282

(51) Int. Cl. H01M 4/88

(52) U.S. Cl. 252/182.1

(57) ABSTRACT

The invention relates to a method for preparing a material including at least one member of the Group 14 by thermal degradation of a ternary phase, also known as the Zintl phase, or by reaction therewith an oxidising solvent. The invention also relates to the material containing at least one element of Group 14 that can be obtained by this method, and to the use thereof mainly in the field of electrochemistry, particularly for batteries. The material is more particularly suited for the field of batteries of the alkaline metal and/or alkaline-earth ions type, in particular of the lithium-ion type.

### TECHNICAL FIELD

The present invention relates to a method for preparing a material including at least one element of Group 14, by thermal degradation of a ternary phase also known as the Zintl phase or by its reaction with an oxidizing solvent.

The invention also relates to the material comprising at least one element of Group 14 obtainable by this method, and its use mainly in the field of electrochemistry, particularly for batteries. Said material is more particularly suitable in the field of alkaline metal and/or alkaline-earth-ion type batteries, in particular lithium-ion type.

Furthermore, the invention relates to an anode made of a material as defined.

The method of the invention allows to obtain a material with an optimal mass capacity able to store and release, in a reversible manner, an alkaline and/or alkaline-earth metal. This makes such a material particularly suitable for use in the field of electrochemistry.

Materials obtainable according to the method of the invention can further be adapted for use in the field of photovoltaics and thermoelectricity.

### STATE OF THE ART

Lithium-ion type rechargeable batteries are highly used in numerous electronical devices. Most of these batteries comprise anodes constituted of materials made of graphite. These materials are able to incorporate lithium by an intercalation mechanism during the recharge of the battery. Anodes made of graphite have, in general, a good cyclability and a good Coulombian efficiency. However, the amount of lithium incorporated per mass unit of a material made of graphite is relatively low, around 300-400 mAh/g.

Another type of material used in the constitution of anodes includes metals able to incorporate lithium by a mechanism involving the formation of an alloy (conversion mechanism) during the battery's recharge. Although this type of anodes allow a higher incorporation of lithium per mass unit compared to anodes made of graphite, the cyclability and the Coulombian efficiency of these anodes are low.

In addition, the anodes cited hereabove have a tendency to undergo an important change in volume during lithiation and delithiation processes. This change in volume can lead to the deterioration of the mechanical and electrical contact between the material's active elements constituting the anode, that is to say, the particles of dilutent conductor (e.g. carbon) and the binding agent. The deterioration of the electric mechanical contact can decrease the insertion ability of lithium totally or partially (the amount of lithium which can be inserted per mass unit) the material of the active anode and its cyclability.

Thus, there is a real need to develop a method allowing to obtain a material having at the same time an optimal mass capacity and a good cyclability.

Moreover, there is a real need to dispose of a method that allows to obtain a material able to store and release, in a reversible manner, an alkaline and/or alkaline-earth metal without an important change in volume.

Furthermore, there is a real need to dispose of a method allowing to prepare a material adapted to a repeated use in batteries and particularly in the anodes of lithium-ion battery.

### DISCLOSURE OF THE INVENTION

The method of the invention allows to obtain, by relatively simple and low cost methods, materials having a very good reversible mass capacity during the alkaline and/or alkaline-earth metal insertion, particularly lithium, and without any electrochemical treatment. The method gives a material that can be used without any other post-synthetic step. Indeed, the elaborated material allows to overcome the mechanical weariness during the insertion of the alkaline and/or alkaline-earth metal, and more particularly lithium, weariness due to a strong variation of volume.

Indeed, the present invention aims precisely at responding answering the needs and inconvenience of the prior art by providing a method for preparing a material comprising at least one element of Group 14, comprising the following steps:
from a material of formula (I):

AxGyMz

in which:
A represents at least one alkaline and/or alkaline-earth metal, in particular selected from lithium, sodium, potassium, rubidium, magnesium and calcium,
x represents an integer between 1 to 20, in particular between 2 to 15, and more particularly from 3 to 12, or even 4 to 10,
G represents at least one element of Group 14 of the Periodic Classification of Elements, particularly selected from silicon, germanium, tin and lead,
y represents an integer between 1 to 17, in particular between 1 to 10, particularly from 1 to 6, and even from 1 to 4,
M represents at least a noble or semi-noble metal, particularly selected from aluminium, cobalt, nickel, copper, zinc and silver, and
z represents 0 or an integer from 1 to 5, particularly from 1 to 3, and even from 1 to 2,
extracting, at least partially, A from the starting compound by thermal degradation under vacuum, or by reacting with an oxidizing solvent, given that when it is a thermal degradation under vacuum, z is different from 0, and
collecting the material impoverished in A or devoid of A.

Within the framework of the present invention, by noble or semi-noble metals, it is to be understood a transitional or post-transitional metal selected more particularly from Groups 9, 10, 11, 12 and 13 of the Periodical Classification of Elements.

The material AxGyMz of formula (I) can be named ternary phase or Zintl phase.

According to a particular embodiment, in the material of formula (I), G can be a mixture of two elements of Group 14 of the Periodical Classification of Elements. In this embodiment, G can be a mixture of silicon and tin. Still according to this embodiment, a particularly interesting material can be a material in which A is lithium, and G is a mixture of silicon and tin.

When the collected material is devoid of A, it will mean that the method of the invention has enabled to extract all of A present in the starting material.

When the material is impoverished in A, it is to be understood a material of formula (IV)

Ax′GyMz

in which
A, G and M are as previously defined,
y and z are as previously defined, and
x′ is a number inferior to y/10

The collected material can advantageously be present under a nanoparticulate form. The said particles can have a spherical or an elongated geometry or a mixture of spherical and elongated. For a spherical geometry, the particles' diameter can be from 2 to 100 nm and their length from 5 to 10000 nm.

By <<elongated geometry>> it is to be understood a non spherical geometrical form, in particular a filaria form type or sensibly filaria, comprising a length superior to the diameter. The particles' geometry and dimensions can be deducted from direct observation by electron microscopy.

According to a first embodiment of the invention, the method for preparing a material comprising al least one element of Group 14 comprises at least a step of thermal degradation under vacuum of a material of formula (II):

AxGyMz

in which:
A represents an alkaline metal, in particular selected from lithium, sodium and potassium,
   x represents an integer between 1 to 20, in particular between 2 to 15, and more particularly from 3 to 12, or even 4 to 10,
   G represents silicon,
   y represents an integer between 1 to 10, particularly from 1 to 6, and even from 1 to 4,
   M represents at least a noble or semi-noble metal, particularly selected from aluminium, cobalt, nickel, copper, zinc, silver, and
   z represents an integer from 1 to 5, particularly from 1 to 3, and even from 1 to 2.

This method can be called <<thermal degradation method>> or <<solid method>>.

In this embodiment, the collected material can be deevoid of A, that is to say the method of the invention has allowed to extract all of A present in the material of formula (II).

The said material can also be impoverished in A, the said material having formula (IV)

Ax′GyMz

in which:
A, G and M are as previously defined,
y and z are as previously defined, and
x′ is a number inferior to y/10

This method allows to obtain a phase containing silicon and at least a noble or semi-noble metal having a good mass capacity.

By mass capacity it is meant the amount of electrons that can be stored per mass unit. In the meaning of the invention, a good mass capacity is a mass capacity superior to graphite and in particular superior to 400 mAh/g and even 500 mAh/g.

As mentioned, the thermal degradation method can allow to extract totally or partially the alkaline or alkaline-earth metal from the starting ternary phase. An X-ray diffraction analysis on the collected material allows to identify therein the presence of two phases of the G and M elements, the width of the bands enables to define a nanoparticle size inferior to 200 nm. An electron microscopy (scanning and/or transmission) observation coupled to a chemical analysis allows to define a structure that is particular to the method: the M particles are homogeneously dispersed in the matrix of G particles. C and M particles, having nanometric sizes, in particular from 1 to 200 nm, in particular from 2 to 100 nm, in particular from 2 to 80 nm.

To proceed with the thermal degradation, the starting ternary phase can be in a powder form, and in particular in the form of small sized particles. This powder can be more particularly obtained by grinding the ternary phase in a mortar.

In the method according to the invention, the thermal degradation can be carried out at high temperature, particularly at a temperature superior or equal to 500° C., in particular superior or equal to 600° C., or even superior or equal to 650° C. The thermal degradation can be preferably carried out at a temperature between 500° and 750° C., and more preferably at 650° C. When A is lithium, the temperature is advantageously superior or equal to 650° C.

This thermal degradation can be carried out for several hours, in particular from 10 to 30 hours, in particular from 15 to 25 hours, and in particular from 18 to 24 hours.

The thermal degradation method can be carried out <<under vacuum>>, that is to say under reduced pressure, in particular a pressure inferior or equal to 10⁻² Pa, in particular solvant oxydant inferior or equal to 10⁻³ Pa, and more particularly inferior or equal to 10⁻⁴ Pa. Preferably the thermal degradation can be carried out under a pressure from 10⁻⁶ to 10⁻² Pa, and more preferably from 10⁻⁵ to 10⁻³ Pa.

Of course, these parameters can be optimized by a person skilled in the art, in particular depending on the starting ternary phase, in particular depending on the nature of element A and/or the aimed application, for instance for the lithium-ion batteries.

For example, a microscopal examination of a material made of silver, silicon and lithium, having a formula and a stoichiometry consistent with the material of formula (IV) showing a black powder and silver metallic clusters, an X-ray diffraction analysis showing thin bands corresponding to silver demonstrating the presence of nanoparticles with a size superior to 50 nm, can bring a person skilled in the art to deduce that the conditions of the thermal degradation have been too drastic, for example in terms of duration, pressure and/or temperature. In the same manner, an X-ray diffraction analysis can show a rest of the alkaline and/or alkaline-earth metal in the collected material and thus bring a person skilled in the art to deduce that the conditions are too mild, in particular in terms of duration, pressure and/or temperature.

The thermal degradation can be carried out in the presence of an oxidizing solvent. In this method, the solvent can allow to extract totally or partially the alkaline and/or alkaline-earth metal of the starting ternary phase.

According to a second embodiment, the method for preparing a material comprising at least one element of Group 14 comprises at least the following steps:
putting into contact an oxidizing solvent with a material of formula (III):

AxGyMz

in which:
A represents at least one alkaline or alkaline-earth metal, in particular selected from lithium, sodium, potassium, rubidium, magnesium and calcium,
x represents an integer between 1 to 12, in particular between 1 to 10, and particularly from 1 to 8,
G represents at least one element of Group 14, particularly selected from silicon, germanium, tin and lead, and
y represents an integer between 1 to 17, in particular between 1 to 15, particularly from 1 to 13, and even from 1 to 10,
z represents 0

collecting the material impoverished in A or devoid of A.

As mentioned before, when the collected material is devoid of A, it means the method of the invention has allowed to extract all of A present in the starting material.

In this second particular embodiment, the material impoverished in A, is a material of formula (IV)

Ax′GyMz

in which:
A and G are as previously defined,
y is as previously defined, and
z is 0
is a number inferior to y/10.

This method of preparation can also be called <<liquid method>>.

The oxidizing solvent can have the two following characteristics:
to carry at least one oxidizing function, that is to say which allows, by reacting with an alkaline or alkaline-earth, in particular of sodium (Na) or potassium (K) type, to emit H₂, this function can particularly be selected from alcohol, amine, thiol, carbonyl, carboxylic acid and phosphonic acid, and
comprising at least an alkyl, aryl or aralkyl group.

The alkyl, aryl or aralkyl groups can in particular be selected from:
linear, branched or cyclic alkyl radicals such as, ethyl, propyl, butyl, pentyl, hexyl, heptyl, octyl, nonyl, decyl, undecyl, dodecyl, tridecyl, tetradecyl, pentadecyl, hexadecyl, octadecyl, nonadecyl, and
aryl and aralkyl radicals, optionally substituted by one or several various substitutents, particularly alkyl type, which alkyl is optionally substituted and/or whose chain can be interrupted by one or several heteroatoms, in particular O, S and N type.

The aryl or aralkyl radicals can particularly be selected from aromatic radicals substituted or not, in particular substituted by at least a halogen atom, a group selected from alkyls, alcohols, thiols, amines, acids, ethers, esters, amides, acids, thioethers, thioesters, as well as by halogen atoms, and particularly the aromatic radicals can be selected from phenyls, benzyls, methoxyphenyls, methoxybenzyls, halophenyls, halobenzyls, and tolyls.

Among oxidizing solvents, benzylic alcohols, in particular mono or poly substituted, for example by one or several alkyl radicals can be cited.

More particularly the alkyl, aryl and aralkyl groups are sufficiently cumbersome to allow the stabilization of nanoparticles.

In this second embodiment, the collected material can then be submitted to a thermal treatment or annealing step. By <<annealing>>, in the meaning of the invention, it is meant a thermal treatment which is carried out at a temperature generally lower than the temperature at which the material has been prepared. This thermal treatment step can especially allow to improve the crystallinity. This can be especially be observed by X-ray diffraction.

The thermal treatment can be carried out at high temperature, notably at a temperature superior or equal to 300° C., particularly superior or equal to 400° C., or even superior or equal to 500° C. The temperature of the thermal treatment is advantageously between 200 and 500° C., between 250 and 400° C. and more advantageously between 300 and 350° C.

The duration of the thermal treatment can be from half an hour to 10 hours, in particular from an hour to 5 hours, more particularly from an hour and half to 3 hours.

The thermal treatment step can be carried out under inert atmosphere, particularly under vacuum, argon or nitrogen. In this particular case, by a <<under vacuum >> we understand a pressure from 10⁻⁶ Pa to 1 Pa and more particularly from 10⁻³ Pa to 1 Pa.

The synthesis of the starting ternary phase can be realised according to methods described in litterature, particularly by Schuster and Kevorkov. Schuster's article (H. U. Schuster, W. Seelentag, Zeitschriff fur naturforschung, Teil B anorganische chemic, organische chemie, 30B (1975) 804) describes a ternary Li₈Ag₃Si₅ system. As for Kevorkov (D. G. Kevorkov, V. V. Pavlyuk, O. I. Bodak, Polish Journal of Chemistry, 71(6)(1997)712) he describes Li₈Ag₃Si₅, Li₃Ag₂Si₃ and Li₂AgSi₂.

For the Pauly phase, there is no structural resolution (the phase is simply cited). Schuster describes Li₈Ag₃Si₅ as isostructural of Li₈Ag₃Ge₅. For Kevrokov's compounds, the structures have been resolved using the Rietveld method (parameters of the lattice+crystalline structure) from the powder. The synthesis was done under vacuum in quartz boats at 200° C. for 400 h.

The ternary phasis can more particularly be prepared by thermal treatment, particularly as described in litterature by H. Pauly, A. Weiss, H. Witte, Z. Metallkde, 59(1)(1968) 47.

The preparation of the material of formula (II), or ternary phase, can comprise at least a step of heating of a mixture of powders comprising:
at least an alkaline metal, in particular selected from lithium, sodium and potassium,
silicon,
at least one noble or semi-noble metal, in particular selected from aluminium, cobalt, nickel, copper, zinc, silver.

These elements can have a purity superior or equal to 95%, in particular superior or equal to 98%, more particularly superior or equal to 99%, and even more particularly superior or equal to 99.5% in weight.

The amount of each element can be determined with respect to its content in the final ternary mixture. Particularly, the amounts are estimated in a stoichiometric manner. More precisely, in a first approach, the amounts are estimated with respect to the stoichiometry of the considered compound, optionally with an excess of the alkaline compound, then these proportions are refined by testing such as <<trial and error>> type.

The increase in temperature, particularly from room temperature, which is 20±10° C., to the temperature in the heating step can be carried out at a speed going from 20 to 500° C./h, in particular from 50 to 500° C./h, even from 80 to 150° C./h, more particularly the speed can be 100° C./h.

The heating is carried out at a high temperature to allow an intimate mixture of the elements. The temperature is determined taking into account the risk of element A's loss by evaporation and the necessity that A is to be present in a liquid form. The temperature can thus be adjusted between the melting point and the boiling point of element A, in particular superior or equal to 600° C., particularly superior or equal to 750° C., and more particularly superior or equal to 850° C., particularly in the case where A is lithium.

The duration of this heating can be a few hours, in particular from 1 to 10 hours, particularly from 2 to 8 hours, even from 4 to 6 hours.

More particularly, the mixture is stirred during the heating step. Particularly, it is stirred from 1 to 20 times during this phase.

The mixture can undergo an annealing step, particularly following the heating step. This step can be carried out at a temperature inferior to the one in the heating step. The temperature of the annealing step can be from 100 to 400° C. lower, in particular from 150 to 350° C. lower, particularly from 200 to 300° C. lower than the heating temperature.

The temperature of the annealing step can be from 500 to 840° C., in particular from 550 to 800° C., particularly from 600 to 750° C.

The annealing step can last some hours, particularly from 3 to 30 hours, in particular from 5 to 25 hours, even 7 to 20 hours, more particularly from 8 to 12 hours.

When the temperatures decrease, particularly between the heating step and the annealing step, and/or between the annealing step and room temperature, which is 20±10° C., this drop in temperature can take place at a rate from 1 to 20° C./h, particularly from 4 to 16° C./h, even from 8 to 12° C./h.

The obtained material can be collected under inert atmosphere by opening the tube and the powder is transferred in the reactor for the thermal degradation step.

The material can be used in the method of preparation of the invention as such, without further treatment.

The method for preparing a material including at least one element of Group 14 according to the invention allows to control the size and/or the crystallinity of the obtained material, particularly the nature of the crystalline plans of the nanoparticles' facets. The size and/or the crystallinity of the nanoparticles allow to obtain a material with interesting properties.

Advantageously, the material obtained is in the form of amorphous nanoparticles. This can especially allow a good insertion of the alkaline and/or alkaline-earth metal in the said nanoparticles.

The invention also relates to a material obtainable by a method according to the invention.

The invention also relates to a material comprising at least one element of Group 14 obtainable by a method according to the invention allowing the insertion, at least partially reversible, of at least an element of alkaline or alkaline-earth metal type.

More particularly, this material presents a mass capacity superior or equal to 800 mA.h.g⁻¹, in particular superior or equal to 1000 mA.h.g⁻¹, particularly superior or equal to 1200 mA.h.g⁻¹, even superior or equal to 1400 mA.h.g⁻¹. As indicated before, the mass capacity means the amount of electron stored per mass units.

During the electrochemical cycle, we also note the presence of the material made of lithium, typically LiAg, which improves the material's electronical and ionic conductivity.

More particularly, the material comprising at least one element of Group 14 obtainable by the thermal degradation method has at least two phases, each can correspond to an element in its elementary state or as pure substance, particularly at least a transition or post-transition metal and silicon.

The material obtained according to the method of the invention can more particularly be present in the form nanoparticles of pure G and/or M, in particular as shown in FIG. 6.

In the context of the present invention, by <<pure nanoparticle>> it is meant a nanoparticle comprising at least 98%, particularly at least 99%, and in particular at least 99.9% in weight of the compound in the nanoparticles.

This material can be present in the form of a dispersion of G or M nanoparticles, in particular of homogenous size, dispersed in a M or G matrix, more particularly of M nanoparticles in a G matrix or of G nanoparticles in a M matrix.

More particularly, this material can be present in the form of a nanocrystalline matrix, in particular with G particles having a size ranging from 2 to 100 nm, and in particular with silicon. Particularly, G is crystallized in a thermodynamically stable form and/or the M metal in a nanoparticle form, particularly having a size from 2 to 50 nm.

Compared to a material obtained by grinding or mechanosynthesis, we observe a very good homogeneity of the dispersion of M nanoparticles in the G matrix, and in particular in silicon, in the material obtained according to the method of the invention.

More particularly, the material comprising at least one element of Group 14 obtained according to the method of the invention can be used in a battery, in particular lithium-ion type. Particularly, as constituants of the anode, alone or in combination with other components.

In case of materials in the form of nanoparticles, the anodes can be made by a simple deposit or compression of these nanoparticles by press or SPS (<<Spark Plasma Sintering>>) type technics.

The material obtained according to the method of the invention, particularly when it is obtained by thermal degradation under vacuum, can present structures of two nanocrystalline phases (G and M), particularly intimately imbricated with a big interface between the two phases, as shown by FIG. 6.

The material obtained according to the method of the invention, particularly when it is obtained by a reaction with an oxidizing solvent, can be in the form of nanoparticles having a non-oxydized surface, meaning that this surface is sensibly non oxydized, even totally non oxydized, according to the classical surface analysis technics.

In both cases, nanoparticles have in particular a length of crystalline coherence (crystallite size) inferior or equal to 5 nm, particularly inferior or equal to 4 nm, more particularly inferior or equal to 3 nm, even inferior or equal to 2.5 nm.

These nanoparticles can have a remarkable crystallinity. A remarkable crystallinity can be defined by the fact that the observed X-ray diffraction size corresponds sensibly to the size observed with an transmission electronic microscopy. By <<sensibly>> it is more particularly meant a difference inferior or equal to 25%, in particular inferior or equal to 15%, particularly inferior or equal to 10%, more particularly inferior or equal to 7.5%, even inferior or equal to 5%.

The fact that the shape of these nanoparticles can be controlled can also allow to modulate the electronical properties.

The invention equally relates to the use of a material comprising at least one element of Group 14 obtainable by the method of the invention in the field of electrochemistry.

According to one of its other aspects, the object of the invention is also a battery comprising a material comprising at least one element of Group 14 obtainable according to the method of the invention.

The invention further relates to an anode made of a material comprising at least one element of Group 14 obtainable according to the method of the invention.

According to another one of its aspects, another object of the invention is the use of a material comprising at least an element of Group 14 obtainable according to the method of the invention to store and release, in a reversible manner, at least an alkaline and/or alkaline-earth metal. This reversible storing and/or release of at least an alkaline and/or alkaline-earth metal can be partial or total. The alkaline metal is advantageously lithium.

Other advantages can still appear to a person skilled in the art when reading the following examples, illustrated by the annexed figures.

### BRIEF DESCRIPTION OF THE FIGURES

FIG. 1 represents an example of thermal profile of a method for preparing a ternary phase.

FIG. 2 represents a diffraction diagram of X-ray of compound Li₁₃Ag₅Si₆ refined according to Rietveld's method.

FIG. 3 represents an example of experimental set-up fixed on a vacuum ramp for carrying out the thermal degradations (1 branching on the ramp; 2 valve; 3 O-ring joint; 4 cooler; 5 alumina tube; 6 stainless counter tube; 7 silica tube).

FIG. 4 represents the evolution of the X-ray powder diffraction diagrams of the different degradations presented in Table 1 of example 1.

FIG. 5 represents a X-ray powder diffraction diagram of the product obtained after thermal degradation under vacuum of Li₁₃Ag₅Si₆ indexed with Ag and Si.

FIG. 6 represents a MET micrograph and electronic diffraction figure of the degradation product of Li₁₃Ag₅Si₆.

FIG. 7 represents a cycling in galvanostatic mode of the Li/LₓAgSi battery.

FIG. 8 represents a cyclability curve associated with the cycling defined in FIG. 7.

FIG. 9 represents a cycling in potentiodynamic mode of the LiₓAgSi battery—1st cycle.

FIG. 10 represents a cycling in potentiodynamic mode of the Li/LiₓAgSi battery—2nd cycle.

FIG. 11 represents a MET micrograph of nanoparticles of Germanium obtained at 20° C. by action of the benzylic alcohol.

FIG. 12 represents an X-ray diffraction of nanoparticles of Germanium obtained at 20° C. by action of the benzyl alcohol on the K₄Ge₉ compound (top: after synthesis; bottom: after annealing).

FIG. 13 represents Germanium nanocrystals obtained at 20° C. by action of 1-butanol on the K₄Ge₉ compound after an ethylene-diamine treatment.

FIG. 14 represents nanostrands of silicon in onions, obtained by action of benzylic alcohol on the K₁₂Si₁₇ compound.

FIG. 15 represents self-organized nanostrands of silicon obtained according to the same method as in FIG. 14.

FIG. 16 represents a cycling in galvanostatic mode of the Li/nanoparticles of Germanium battery shown in FIG. 12.

### EXAMPLES

### Example 1

### Preparation of an Li₁₃Ag₅Si₆ Alloy

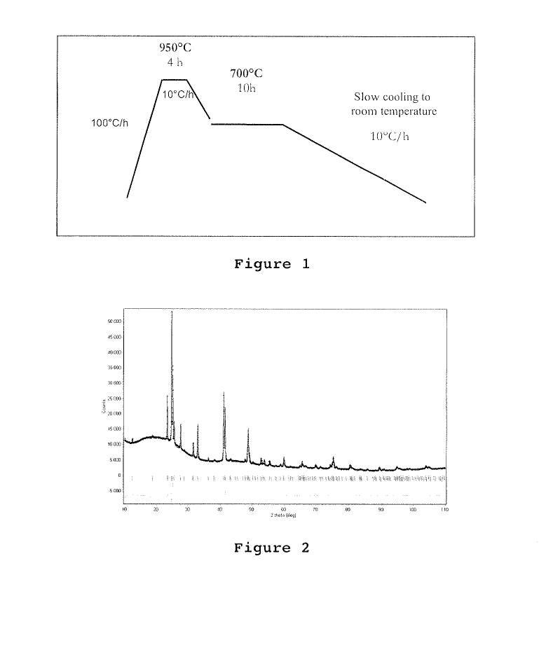

A mixture of 0.117 g lithium (bullion, pure at 99.54%, Cogema), 0.913 g silver (needles, pure at 99.999%, Strem Chemicals) and 0.237 g silica (powder, pure at 99.998%, Goodfellow) has been inserted in a tantalum reactor sealed by arc welding, itself inserted in a silicon tube which is then sealed under vacuum. This reactor has then been placed in an oven with an increase in temperature from room temperature to 950° C. at 100° C./h, then 4 hours at 950° C., cooling at 10° C./h to 700° C., heating at 700° C. during 10 hours, then cooling until room temperature at the rate of 10° C./h. this thermal profile is illustrated in FIG. 1.

An elementary semi-quantitative analysis with a microprobe (MEB) and an atomic absorption spectrometry of a crystal isolated from the preparation, provide a compound of Li₁₃Ag₅Si₆ stoichiometry.

This compound has been studied by powder and monocrystal X-ray diffraction. The diffraction diagram of the powder is represented in FIG. 2. All the peaks are perfectly indexed in the Rhomboedric R-3m lattice with parameters a=0.4376 nm and c=4.2293 nm (hexagonal axes).

### Example 2

### Preparation of an Active Material

The Li₁₃Ag₅Si₆ material, obtained after the synthesis, is grinded in an agate mortar to allow a better extraction of lithium.

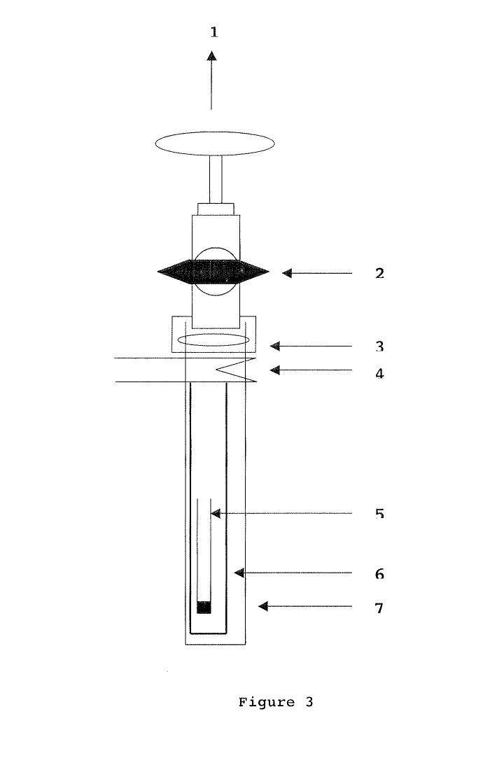

This powder is placed in a small alumina tube which is itself placed in a stainless steel tube, the entirety is inserted in a silica tube locked by a valve. The stainless steel tube protects the silica from the attacks of the lithium fumes. The setting is thus constituted of three tubes: the small alumina tube containing the powder, the stainless steel counter tube and the silica tube. Such a setting is illustrated in FIG. 3.

Then the setting is directly assembled on the vacuum ramp. The primary vacuum is first made using an oil pump, then a secondary vacuum is created with a diffusion pump having a resistance. The vacuum obtained with the silica tube is about of 10⁻⁷ mbar. The tube set on the vacuum ramp then slides in a horizontal tubular oven. A cooler is installed at the outlet of the stainless tube to allow the lithium condensation at the exit of the alumina tube.

The new vacuum conditions have required different tests to enable the extraction of all the lithium contained in the sample. Temperatures varying from 550° C. to 650° C. have been tested as well as extraction durations from 15 to 30 hours.

Results of the four degradations with different temperature and duration conditions are collected in the following Table 1.

TABLE 1

| Degradation | 1 | 2 | 3 | 4 |
|---|---|---|---|---|
| Temperature | 550 | 650 | 650 | 650 |
| [° C.] | | | | |
| Vacuum [bar] | 10⁻⁶ | 10⁻⁶ | 10⁻⁶ | ⋄ |
| Duration [H] | 15 | 15 | 24 | 30 |
| Phases detected | LiAgSi | Ag, Si | Ag, Si | Agglomerated |
| by RXD | Ag, other | LiAgSi | | Ag, Si |

Experimental conditions of the different thermal degradations for the Li₁₃Ag₅Si₆ compound.

The first degradation has been carried out at 550° C. during 15 hours. The analysis of the obtained product by X-ray powder diffraction shows the main phase is the starting Li₁₃Ag₅Si₆ phase, in a less important amount we observe silver and impurities. We can thus think that the thermal degradation of this compound at 550° C. does not enable the extraction of lithium.

A second test at 650° C. during 15 hours was carried out. The X-ray analysis of the product shows that the starting compound has been decomposed into simple pure substances of silver and silicon, however there remains a residue of the starting phase.

In order to extract all the lithium we decided to extend the degradation time to 24 hours. This test is conclusive and the phases present are silver and silicon.

To complete these tests we maintained the degradation temperature at 650° C. and extended the extraction time to 30 hours. A microscopic examination of the product shows a black powder and silver metallic clusters, allowing to deduce that a 30 hour degradation is too long and provokes an agglomeration of the silver.

The optimal thermal degradation conditions under a 10⁻⁶ mbar vacuum for the Li₁₃Ag₅Si₆ compound are a temperature of 650° C. during 24 hours.

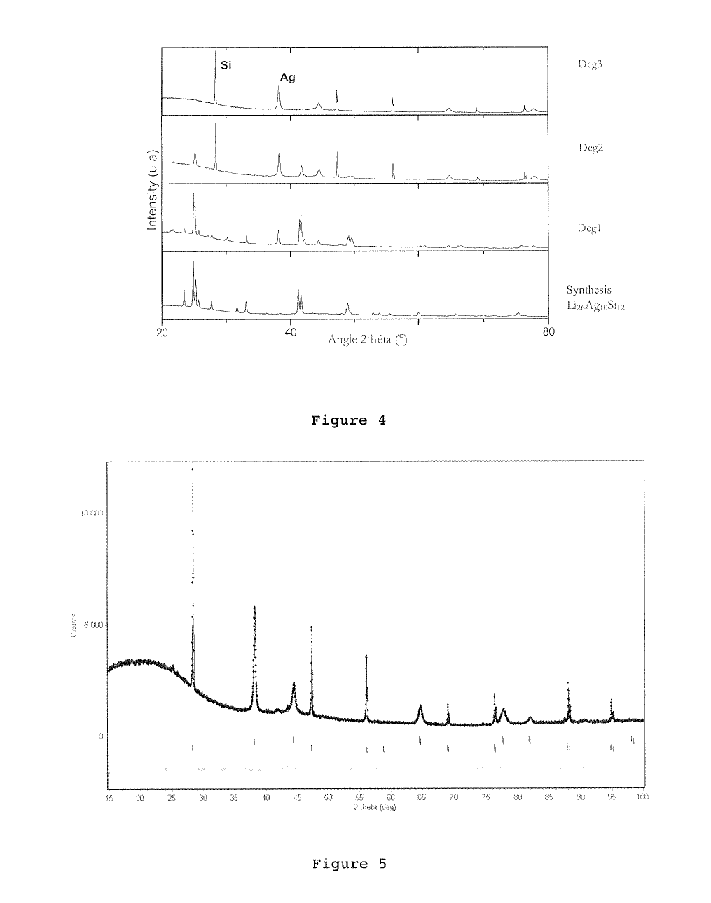

The evolution of X-ray powder diffraction diagrams of the different degradations is represented in FIG. 4 where <<deg 1,2,3 and 4 >> means degradation conditions 1, 2, 3 and 4 as presented in table 1.

We can see on this figure the progressive disappearance of the synthetised Li₁₃Ag₅Si₆ phase, which totally disappears at degradation 3. We see silver peaks appearing from the first degradation, and finally silicon peaks from degardation 2. Our aim is now to study more in detail the powder diagram of the degraded product and to know the morphology of the obtained silver and silicon particles.

The X-ray powder diffraction diagram of the obtained product after thermal degradation under vacuum of the Li₁₃Ag₅Si₆ compound shows the presence of two phases. They are in fact two elements in their elementary state, silver and silicon. This diffractogram is presented in FIG. 5.

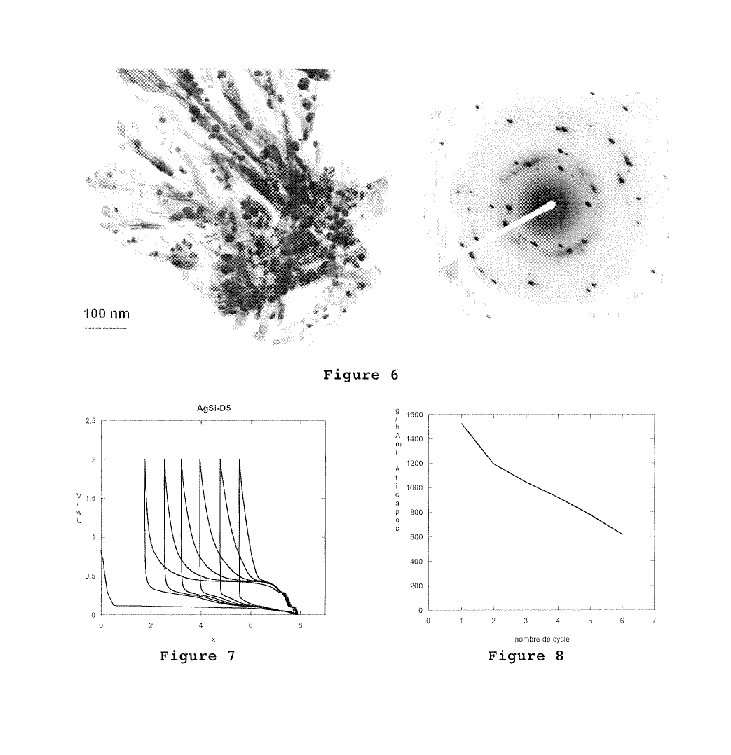

MET micrographs of the degradation product are presented in FIG. 6.

### Example 3

### Use in Electrochemistry

The products degraded according to the degradation of example 2 have next been tested in electrochemistry in Swagelock type cells. The imposed rate is 1 lithium in 10 hours and the potential window is comprised between 0.01V and 2V.

The insertion of lithium in the AgSi matrix allows to reach the Li₈AgSi stoichiometry, after the first charge, we extract up to 6 atoms of lithium to reach the Li₂AgSi stoichiometry. The capacity progressively decreases during the following cycles (FIG. 7).

The cyclability curve (FIG. 8) shows that the capacities obtained for the first cycles are very high (1500, 1200 mA.h.g⁻¹).

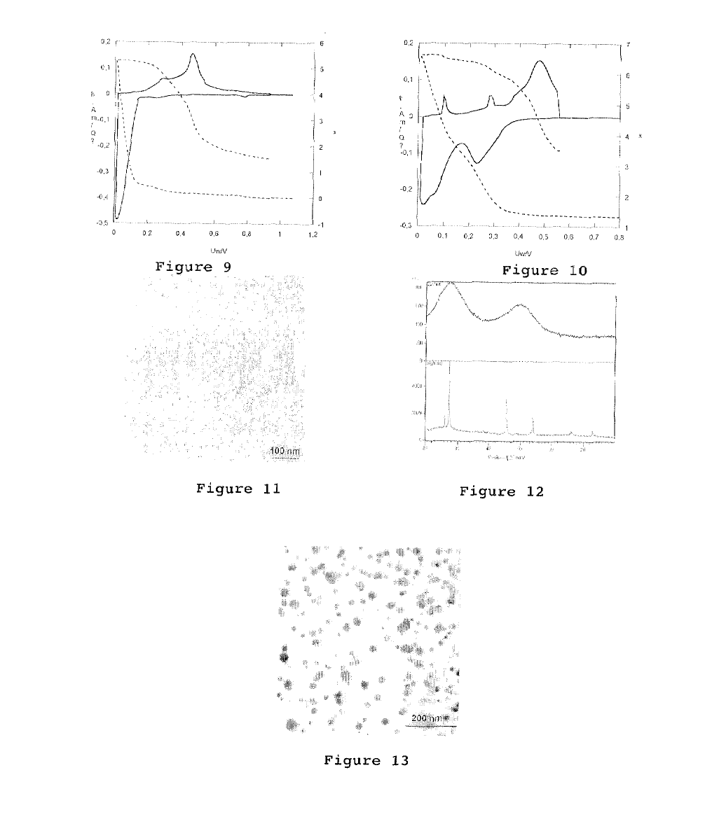

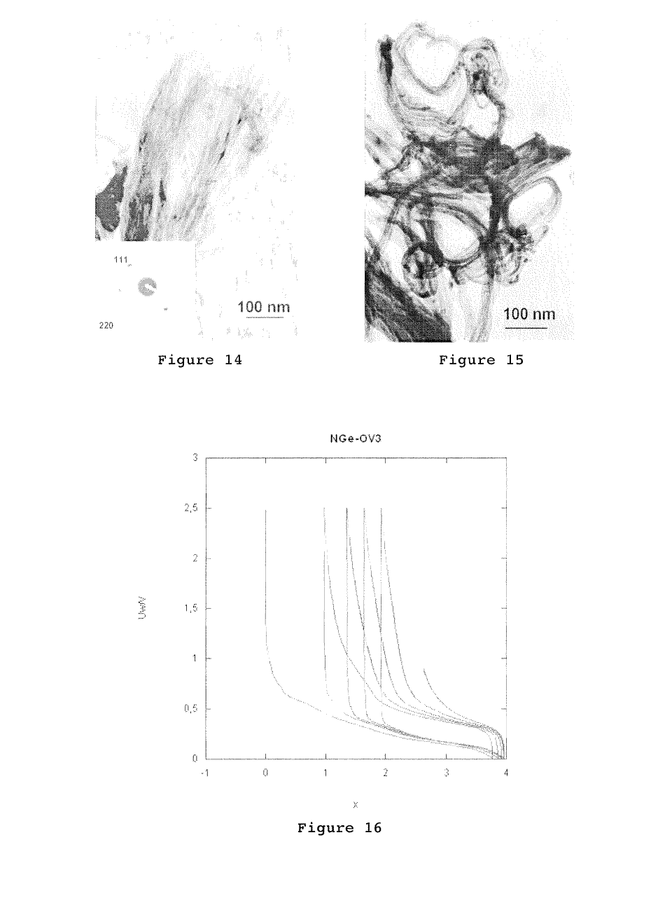

To understand the mechanisms, we represented the cycling tests in potentiodynamic mode in FIGS. 9 and 10.

For the first cycle, during the first discharge we observe an intense peak at 0.02V which corresponds to the plateau of the curve in galvanostatic mode (change in phase), there are then two small peaks at 0.25V and 0.78 V (insertion of Li in amorphous carbon). During the first charge we observe 3 peaks: two small peaks at 0.1V and 0.28 V, a broad and intense peak at 0.45V (single phase phenomenon).

During the 2^{nd} cycle, the phenomena are reproducible and the peaks are more intense.

### Example 4

### Preparation of K₄Ge₉ Alloy

The alloys are prepared from elements weighed in stoichiometric amounts in a glove box. Potassium (Aldrich 99.5%, rod, m=0.630 g) and germanium (Strem, powder, 99.999%) are placed in a tantalum tube sealed at one extremity and then sealed under argon at its second extremity. The tantalum tube is protected by a silica counter-tube sealed under vacuum. The whole is heated at 730° C. during 24 hours, then 930° C. during 24 hours.

The obtained alloy is homogenous, has a black color with red reflections and is characterized by X-ray powder diffraction (cell under an argon bell jar) and stored in a glove box. K₄Ge₉ presents an arrangement of Group 14 atoms in polyhedrons (Ge₉⁴⁻ in the form of a trigonal tricapated prism).

### Example 5

### Method for Sythetizing Germanium Nanoparticles

The K₄Ge₉ alloy (100 mg) prepared according to the method described above is put in a glass reactor having an exit of rotaflo type, in a glove box. 10 ml of benzylic alcohol dried beforehand on a molecular sieve and degassed with argon are added with a cannula to a vacuum ramp. The mixture is stirred for 2 hours at room temperature. The black colored solution is then placed in a centrifugation tube. A centrifugation at 4000 rotations/minute for 20 minutes enables to obtain a black colored powder. The characterization using X-ray diffraction and transmission electron microscopy allows to settle the presence of germanium nanoparticles having a mean diameter 2.0+/−0.2 nm (diamond structure of the massive germanium). These nanoparticles are presented in FIG. 11 and the X-ray diffraction of these particles is represented in FIG. 12.

### Example 6

### Use of the Germanium Nanoparticles as Anodes in a Lithium-Ion Battery

The germanium nanoparticles powder (8.5 mg) is compacted in a glove box with 1.5 mg graphite to form a pellet. The anode is tested in galvanostatic mode at a C/10 rate (1 lithium ion inserted in 10 hours) between 0.01 and 2.5V. The electrochemical discharge/charge curve is presented in FIG. 16. We can see a constant weak polarisation (difference between the charge and discharge) during the cycling. The germanium inserts almost 3 lithium ions. As the figure shows, once the first discharge takes place, the cycles are simply shifted. However, we observe, in the first cycle, an irreversible loss of capacity of 360 mAh.g⁻¹. The loss of capacity progressively during the cycling, is relatively important (about 100 mAh.g⁻¹), but decreases in between each cycle.

1. Method for preparing a material comprising at least one element of Group 14, comprising the following steps:
from a material of formula (I):
AxGyMz
in which:
A represents at least one alkaline or alkaline-earth metal, selected from lithium, sodium, potassium, rubidium, magnesium and calcium,
x represents an integer between 1 to 20,
G represents at least one element of Group 14 of the Periodic Classification of Elements, selected from silicon, germanium, tin and lead,
y represents an integer between 1 to 17,
M represents at least a noble or semi-noble metal, selected from aluminium, cobalt, nickel, copper, zinc and silver, and
z represents 0 or an integer from 1 to 5,
extracting, at least partially, A from the starting compound by thermal degradation under vacuum, or by reacting with an oxidizing solvent, given that when it is a thermal degradation under vacuum, z is different from 0, and
collecting the material impoverished in A or devoid of A.

2. Method for preparing a material according to claim 1, characterized in that in the material of formula (I), G is a mixture of silicon and tin.

3. Method for preparing a material comprising at least one element of Group 14 according to claim 1, comprising at least one step of thermal degradation under vacuum of a compound of formula (II):
AxGyMz
in which:
A represents an alkaline metal, selected from lithium, sodium and potassium,
x represents an integer between 1 to 20,
G represents silicon,
y represents an integer between 1 to 10,
M represents at least a noble or semi-noble metal, selected from aluminium, cobalt, nickel, copper, zinc and silver, and
z represents an integer from 1 to 5.

4. Method for preparing a material comprising at least one element of Group 14 according to any of claims 1 to 3, characterized in that the material impoverished in A, has a formula (IV)
Ax′GyMz
in which:
A, G and M are as previously defined above,
y and z are as previously defined above, and
x′ is a number inferior to y/10.

5. Method according to claim 1, characterized in that the pressure is inferior or equal to 10⁻² Pa.

6. Method according to claim 1, characterized in that the thermal degradation is carried out at a temperature superior or equal to 500° C.

7. Method according to claim 1, characterized in that the thermal degradation is carried out from 10 to 30 hours.

8. Method for preparing a material comprising at least one element of Group 14 according to claim 1, comprising at least the following steps:
putting into contact an oxidizing solvent with a material of formula (III):
AxGyMz
in which:
A represents at least one alkaline or alkaline-earth metal, in particular selected from lithium, sodium, potassium, rubidium, magnesium and calcium,
x represents an integer between 1 to 12,
G represents at least one element of Group 14, particularly selected from silicon, germanium, tin and lead, and
y represents an integer between 1 to 17,
z is 0
collecting the material impoverished in A or devoid of A.

9. Method for preparing a material comprising at least one element of Group 14 according to claim 8, characterized in that the material impoverished in A, is of formula (IV)
Ax′GyMz
in which:
A and G are as previously defined,
y is such as previously defined, and
z is 0,
x′ is a number inferior to y/10.

10. Method according to any of claims 8 or 9, characterized in that the oxidizing solvent has the two following charateristics:
to carry at least one oxidizing function selected from alcohol, amine, thiol, carbonyl, carboxylic acid and phosphonic acid, and
comprising at least an alkyl, aryl or aralkyl group.

11. Method according to claim 10, characterized in that the alkyl, aryl or aralkyl groups are selected from:
linear, branched or cyclic alkyl radicals such as ethyl, propyl, butyl, pentyl, hexyl, heptyl, octyl, nonyl, decyl, undecyl, dodecyl, tridecyl, tetradecyl, pentadecyl, hexadecyl, octadecyl, nonadecyl, and
aryl and aralkyl radicals, eventually substituted by once or more by an alkyl, which alkyl is optionally substituted and/or whose chain can be interrupted by one or several heteroatoms.

12. Method according to claim 9, characterized in that the material of formula (IV)
Ax′GyMz
as defined in claim 9, is submitted to a thermal treatment step.

13. Method according to claim 12, characterized in that the temperature of the thermal treatment is superior or equal to 300° C.

14. (canceled)

15. (canceled)

16. (canceled)

17. Battery comprising a material comprising at least one element of Group 14 obtainable by a method as defined according to claim 1.

18. Anode comprising a material comprising at least one element of the Group 14 obtainable by a method as defined according to claim 1.

19. Method of storing and releasing in a reversible manner at least one alkaline and/or alkaline-earth metal using a material comprising at least one element of Group 14 obtainable by a method as defined according to claim 1.
